(19) United States
(12) Patent Application Publication
(10) Pub. No.: US 2007/0102183 A1
(43) Pub. Date: May 10, 2007

(54) Flexible traction element

(76) Inventors: Pierangelo Jotti, Niederwil (CH); Rio Gasparini, Ennetbaden (CH); Richard Phillips, Trevaux (CH); Jasmin Hodzic, Auenstein (CH)

Correspondence Address: BACHMAN & LAPOINTE, P.C., 900 CHAPEL STREET, SUITE 1201, NEW HAVEN, CT, 06510, US

(21) Appl. No.: 10/580,570

(22) PCT Filed: Dec. 3, 2004
(86) PCT No.: PCT/CH04/00721

§ 371 Date: May 24, 2006

(30) Foreign Application Priority Data
Dec. 5, 2003 (CH) 2081/03

(51) Int. Cl. H02G 3/04

(52) U.S. Cl. 174/68.1

(57) ABSTRACT

A flexible traction organ that can be wound and unwound, in particular for passenger and/or goods lifts, said organ comprising at least one stranded cable consisting of a tensile resistant material. The core strand of each stranded cable is surrounded by a flexible thermoplastic plastic layer. A production line for embedding several stranded cables in a flexible thermoplastic layer comprises a respective reel for unwinding the stranded cable, a device for accurately aligning the stranded cable, a heating element for pre-heating the stranded cable, at least one extruder for co-extruding the stranded cable in a flexible plastic sheathing, a cooling vat, a reel storage unit, a cutting unit and a reserve reel. The extruder, a wire guide and at least one die can be adjusted individually, conjointly and in relation to one another on a plane (P) that runs at an angle to the cable plane (E). The unwound stranded cables are degreased and/or pre-treated to improve the adhesion of the plastic sheathing, and pre-heated to a temperature of approximately ±20° C. in relation to the melting temperature of the flexible, thermoplastic plastic that surrounds the core strand and are sheathed with liquefied plastic in the extruder.

### BACKGROUND OF THE INVENTION

The invention relates to a flexible traction element which can be wound and unwound, in particular for passenger and/or goods lifts, which comprises at least one stranded cable made of a material guaranteeing tensile strength. The invention also relates to a production line for embedding a plurality of stranded cables in a flexible thermoplastic plastics material, which production line comprises, in each case, a reel for unwinding the stranded cables, a device for the precise orientation of the stranded cables, a heater for preheating the stranded cables, at least one extruder for co-extrusion of the stranded cables in a flexible plastics material jacket, a cooling trough, a roller store, a cutting device and a storage roller. Finally, the invention relates to a method for embedding at least one stranded cable in a flexible thermoplastic material.

U.S. Pat. No. 3,348,585 relates to a method and a device for producing industrially usable bands made of rubber with strands, also called wires or threads, made of ferromagnetic material, embedded therein and running approximately in parallel in the longitudinal direction. The strands consist in particular of steel, with their magnetic properties being used as tensile and spacing forces.

GB 1362514 relates to a coiler for band-shaped lifting cables, in which steel bands are sheathed by a synthetic plastics material, in particular by polyurethane. Various flat lifting cables are shown in the drawings. FIG. 1 shows a broad, flat cable with steel strands, which are sheathed by polyurethane. Longitudinally running recesses 17 are also shown in the plastics material jacket, these being designated as insignificant. In FIG. 2, a band-shaped lifting cable with longitudinally extending steel strands is also shown in a plastics material jacket, which has smooth surfaces on either side, in other words has no longitudinally extending recesses.

WO 03/042085 A2 describes a method for producing a lift band with a plurality of bands or braids (cords) in a flat jacket, in which the braids are oriented in a selected arrangement. A special jacket material is selected and the strands are finally individually tensioned such that they are at a uniform distance everywhere from the smooth surface of the plastics material band. The band-shaped lift band minimises the production of disturbing noises and vibrations during lift operation.

The inventor has set himself the object of providing a traction element, a production line and a method for the production thereof according to the manner mentioned at the outset, which ensure increased flexibility in a traction element with a plurality of stranded cables and also improved adhesion over the long term between the stranded cables and the plastics material jacket, and more precisely and reliably control the spacing of the stranded cables guaranteeing tensile strength from the band surfaces even at increased production speed, and deliver band-shaped traction elements of the best commercially available quality.

### SUMMARY OF THE INVENTION

With respect to the traction element, the object is achieved according to the invention in that the core strand of each stranded cable is sheathed by a flexible thermoplastic plastics material layer.

In order to produce stranded cables, at least six peripheral strand cords are wound around a central strand cord designated a core strand. The strand cords themselves, which are in turn stranded, consist of individual fibres or wires of a material guaranteeing tensile strength. The flexibility of a conventional stranded cable can be considerably increased again according to the invention; the coating of the core strands prior to applying the peripheral strand cords also opens the way to higher flexibility without conventional lubricants. The thermoplastic plastics material is made at least partially capable of flowing, but without becoming highly liquid, and applied.

The thickness of the thermoplastic plastics material layer is expediently in the range of 0.1 to 1 mm, the diameter of the core strands being one of the determining factors. The temperature region applied during stranding, for example 100 to 200° C., can cause penetration of the plastics material into cable grooves, but discharge from the surface of the stranded cable is avoided as far as possible. The outer surface of the stranded cables remains bare and is expediently degreased. Individual cables are preferably covered with a protective covering, in particular in the case of larger external diameters of the stranded cable in the range of about 5 mm or more.

Stranded cables of smaller diameter, for example with a diameter of approximately 1 to 3 mm, are in practice sheathed, running in parallel, with a flexible thermoplastic plastics material, for example by a co-extrusion method, while observing optimum adhesion conditions for the plastics material jacket. The degreasing mentioned, a plasma treatment or the application of an adhesion-promoting layer, for example, contribute substantially to this. Lift bands, have, for example, eight stranded cables of 2 mm in diameter arranged on a plane, with a plastics material jacket of 25×4 mm in cross-section. The lift band is a stable composite, which is extremely flexible and forms a traction element which can easily be wound and unwound.

The individual fibres guaranteeing tensile strength, of the stranded cables are, for example steel, aramid, glass, ceramic or carbon fibres. The flexible thermoplastic plastics material sheathing the core strands of the stranded cables consists of polythene, polypropylene, polyurethane or polystyrene, for example. The stranded cables with coated core strands are preferably embedded in the same flexible thermoplastic plastics material.

In relation to the production line for sheathing at least one stranded cable with a flexible thermoplastic plastics material, the object is achieved according to the invention in that the extruder has a thread guide for the stranded cables and at least one matrix, which can be adjusted with and in relation to one another, individually, in a plane P angled with respect to the cable plane. Special and refined embodiments are in turn the subject of dependent claims.

The stranded cables run through the extruder and the outlet opening of the matrix, lying on one plane E. Above all in the case of flat traction elements, it is of substantial significance that the stranded cables lie on one plane so the parallel surfaces of the plastics material jacket have approximately the same spacing everywhere from the embedded stranded cables. By means of a relative displacement of the thread guide, which is also called a wire guide, relative to the matrix, the relative position of the stranded cables changes in the nozzle outlet opening and therefore the position of the stranded cables in the plastics material jacket also changes. The thread guide and the matrix can also be displaced together, in other words with respect to height, without their spacing changing. The plane P which is angled with respect to the cable plane E has an angle of preferably 45 to 135°; in particular, the two planes extend at an angle of about 90°.

If a plurality of stranded cables arranged in parallel run on a plane through the production line, pressure rollers may be arranged directly downstream from the extruder. These consist, for example, of at least one pair of rollers, in particular two pairs of rollers, which can be adjusted in a direction which is at right angles to the traction element passing through. Thus, the position of the stranded cables can be corrected in the still soft plastics material, but only in the fine range of a few tenths of millimetres. The pressure rollers may, however, also be arranged offset in the longitudinal direction of the traction element and thus act on the still soft composite.

Further details of the production line are shown in the drawings and correspondingly described.

Obviously, the production line can also be used for sheathing individual stranded cables or a plurality of stranded cables not located on a plane. The devices which are important to the invention, in this case, are not operated or removed if superfluous.

Finally, the object is achieved in relation to the method for embedding at least one stranded cable with a plastics material-coated core strand according to the invention in that the unwound stranded cables are degreased and/or pretreated to improve the adhesion of the plastics material jacket, preheated to a temperature of about ±20° C. of the melting temperature of the flexible thermoplastic plastics material sheathing the core strands and sheathed in the extruder with the liquefied plastics material. Special and refined embodiments are the subject of dependent claims.

The preheating takes place, for example, with an induction heater, a flame burner and/or a hot air heater. In this case, residual gases inter alia are removed and the adhesion of the plastics material sheathing and the stranded cables is improved.

The sheathing of stranded cables with a flexible thermoplastic plastics material for producing a traction element by means of co-extrusion is possible in an optimal manner owing to the inventive knowledge. The degreasing or coating of the free surface of the stranded cables with an adhesion promoting layer and the preheating to about ±20° C. of the melting temperature of the liquefied plastics material play a decisive role and overall, a sharp improvement in the adhesion between the stranded cables and the plastics material jacket is achieved. The improvement also lasts over long-term and intensive use. Even the lasting deflection around comparatively narrow radii at high tensile forces, which is the case during operation of lifts, does not impair the adhesion between the stranded cables and plastics material, or only to a negligible extent, viewed over the long term.

With the method according to the invention, the economy of the process can also be improved. A very high running speed in the region of 10 to 60 m/min. is achieved.

Each individual stranded cable is tensioned, preferably with a tensile force of 5 to 100 N, in particular 35 to 45 N. If an extruder is used with a cable guide which can be displaced in relation to the matrix, the tensioning of the stranded cables is less critical.

The geometrical cross-sectional shape of the traction elements is decisively determined by the outlet opening of the extruder, in particular when a plurality of parallel stranded cables are being sheathed with a joint plastics material. A band form is preferred with stranded cables arranged on a plane, which generally have cross-sectional external dimensions in the region of 15×1, 5 to 100×20 mm. The cross-sectional dimensions also depend, in particular, on the external diameter of the stranded cables, which is most frequently 1 to 5 mm in particular about 2 mm. The position of the stranded cables, guided in parallel, in the embedded plastics material, can be adjusted by the relative adjustment of the cable guide/matrix to ±0.1 mm accuracy. The correction range is ±0.5 to 2 mm.

In the case of stranded cables located on a plane with a jacket, which has two outer faces located parallel to the plane of the stranded cables, the relative position of the stranded cables and the outsides of the jacket can still be modified. At least two pressure rollers are preferably arranged for this purpose directly downstream from the extruder, as already mentioned. These can also provide the surface of the traction element running through with a certain structure, for example a roughened surface. In the case of traction elements located on top of one another, the coefficient of friction is thus substantially increased and the band-shaped traction elements can thus be wound to form more dimensionally stable band rolls.

The traction elements according to the invention have a wide range of use. They are particularly suitable for the lifting and pulling of loads when the traction element is deflected once or repeatedly and/or stored on a coiler. Lift bands or cables are an important application area and have to meet high safety requirements. In the case of a strand diameter of about 2 mm, they have a tensile strength of at least about 4000 kN/steel stranded cable. In the case of appropriate strand material, the traction elements may also be used as electric conductors.

### BRIEF DESCRIPTION OF THE DRAWINGS

The invention will be described in more detail with the aid of embodiments shown in the drawings, which are also the subject of dependent claims. In the drawings, schematically:

FIG. 1 shows a production line for producing band-shaped traction elements,

FIG. 2 shows a cross-section through various traction elements,

FIG. 3 shows a horizontal section through a thread guide and a matrix,

FIG. 4 shows a vertical section through a thread guide and a matrix with a holder, along a stranded cable,

FIG. 5 shows a vertical section through a thread guide and a matrix,

FIG. 6 shows a vertical section through a thread guide and a two-part matrix,

FIG. 7 shows a variant of FIG. 6 and

FIG. 8 shows a cross-section through a stranded cable.

### DETAILED DESCRIPTION

A production line 10 shown in FIG. 1 for producing band-shaped traction elements 38 with stranded cables 16 according to FIG. 8 made of twisted steel fibres and a rectangular jacket 39 made of a flexible thermoplastic plastics material begins at a system 12 with, in the present case, two times eight reels 14 for unwinding the flexible stranded cables 16 and ends with a storage roller 18 for winding the band-shaped traction elements 38. In industrial production systems, the production line 10 is several dozen metres long.

For the production of traction elements 38, for example lift bands, the diameter Ø of the flexible stranded cables 16 is 2 mm in the present case. All the stranded cables 16 have to have the same, constant, diameter Ø so they can be positioned precisely in the middle of the jacket 39 made of plastics material. The diameter tolerance is at most ±0.05 mm. The stranded cable 16 must not be welded nor have twisting defects. Finally, the stranded cable 16 must be faultlessly wound onto the reel 14.

The individual control of the tensile force of the stranded cables 16, which is held at about 50 N, takes place in a manner which is known per se with a pneumatic or electromagnetic system.

After unrolling, the stranded cables 16 are firstly moved into a plane by way of a stand 20 with a horizontal guide slot. As the stranded cables 16 should be clean and whenever possible without volatile gas components on the surface, they are guided in-line through a cleaning system 22.

Directly downstream from the cleaning system 22, the stranded cables 16 pass through a further stand 24 with a device for the exact orientation of the stranded cables 16 at a constant horizontal spacing. Oriented in this way, the stranded cables 16 pass through an induction heater 26, a flame burner 28 and a hot air heater 30 and after this preheating, the stranded cables 16 have a surface temperature in the region of 100 to 200° C. and all residual gases are removed for the subsequent plastics material coating.

The oriented, cleaned and preheated stranded cables 16 pass through an extruder 32 with a wire or thread guide and matrix according to the invention, shown in detail in FIGS. 3 to 6. The liquefied plastics material, in the present case polyurethane, is supplied perpendicularly to the running direction 80 of the stranded cables 16 shown by an arrow. The plastics material is poured, in powder or granulate form, into a filter 34, whence the bulk material, which is not visible, pours into a horizontal feed screw 36. During the feed, the plastics material is liquefied and pressed by way of the thread guide into the matrix, where the stranded cables 16 passing through in parallel are sheathed with plastics material. The extruder 32, which is known per se with the exception of the thread guide and the matrix, ensures a constant supply of plastics material and excellent quality without gelled or crystallised plastics material particles. The discharge opening 90 (FIGS. 5, 6) of the matrix defines the outer dimensions of a traction element 38 which is sheathed with plastics material.

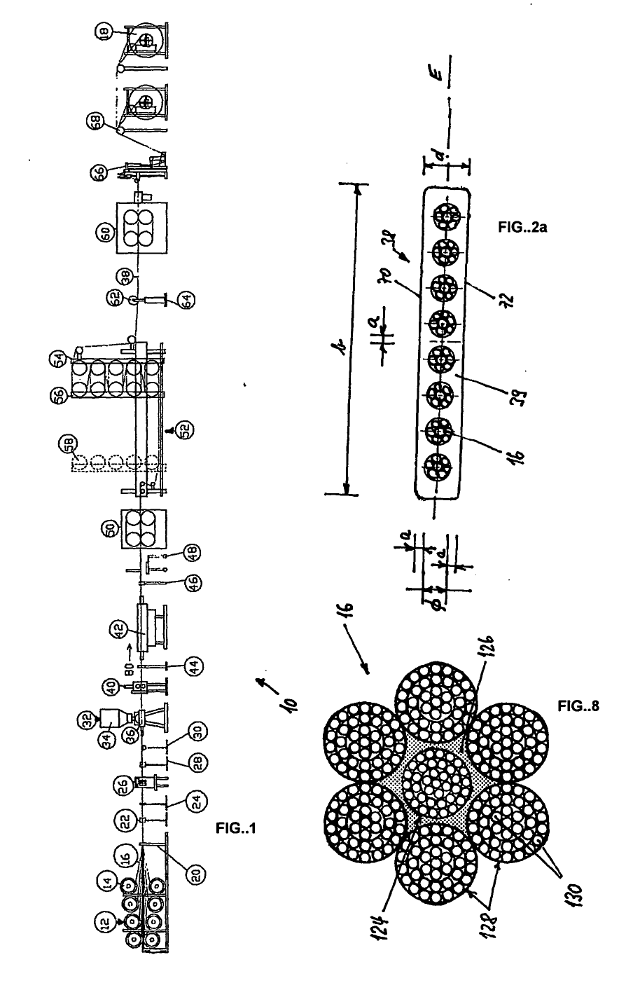

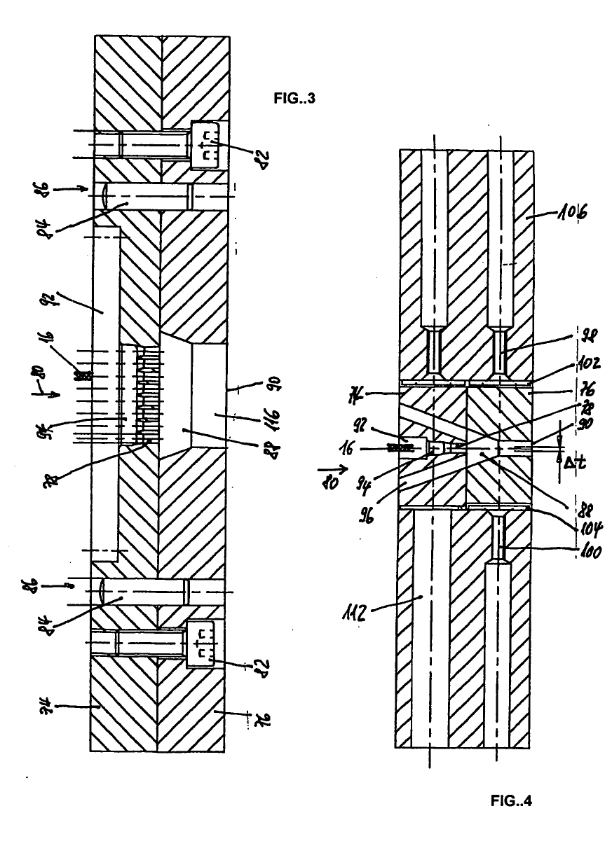

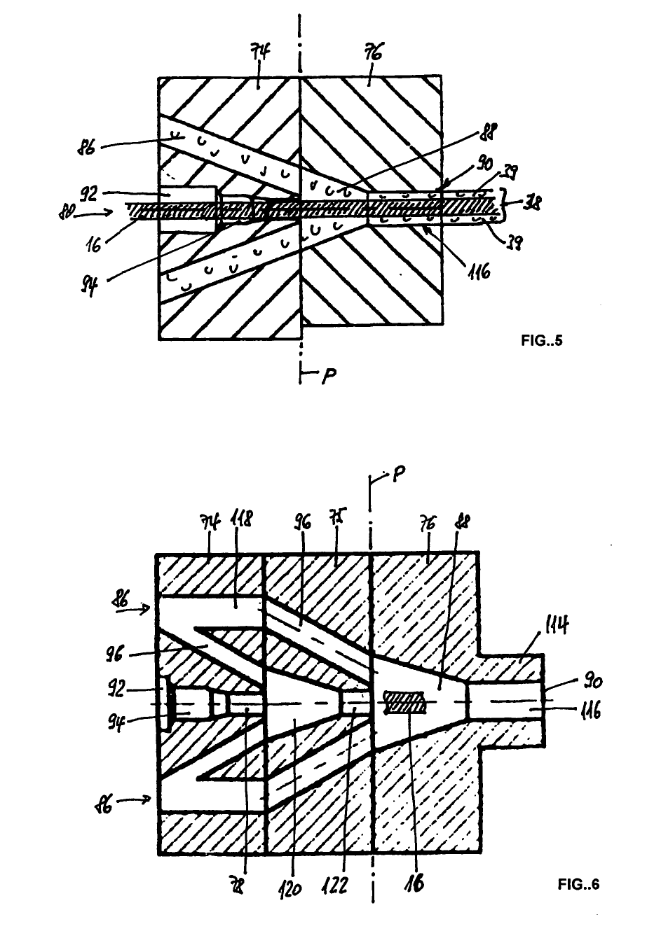

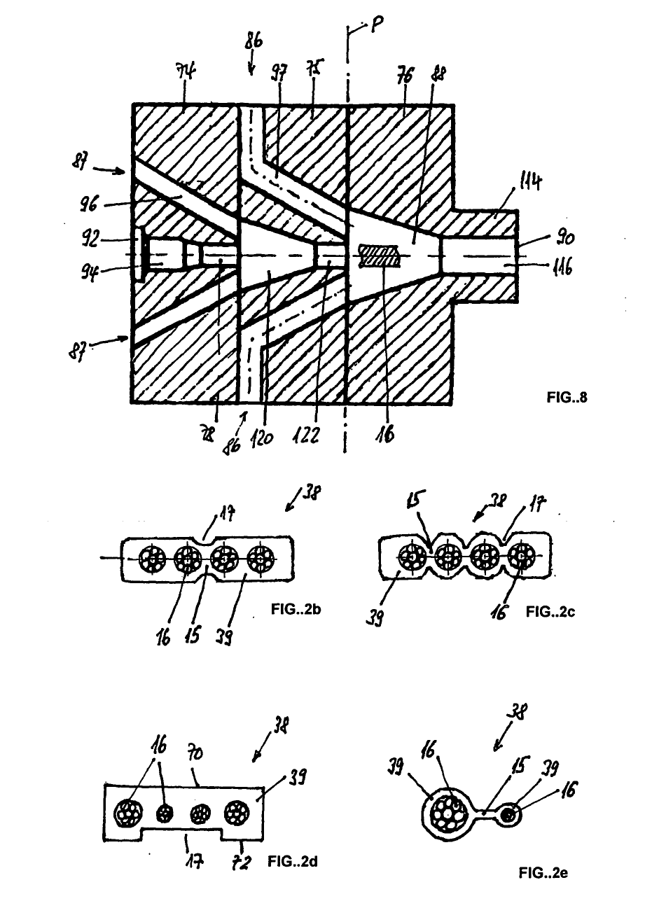

The final dimensions of a traction element 38 are established by the subsequent pressure rollers 40 made of tetrafluoroethylene (TEFLON, Du Pont) or a material coated with TEFLON. Two pairs of rollers 40 also establish the surface structure of the traction element 38. The pressure rollers 40 must not bind with the still warm, soft material of the traction elements and have to be precisely adjustable with respect to the roller gap and the height, and be dimensionally stable. The roller surfaces are roughened in the present case and precisely cylinder jacket-shaped. This produces traction bands of elongate rectangular shape and with a roughened surface according to FIG. 2a.

Downstream from the pressure rollers 40, the still warm traction element 38 runs into a cooling trough 42 of 20 to 40 m in length, for example. In FIG. 1, the cooling trough 42 is shown in very shortened form. In a first section of the cooling trough 42, the traction element 38 can be introduced into hot water of, for example, 65° C. In one or more further sections of the cooling trough 42, the traction element 38 is guided through cooler and cooler water, finally through normal mains or industrial water at tap temperature. According to a variant, the entire cooling trough 42 may contain unheated mains or industrial water. While passing through, the traction element 38 is guided straight, with application of a tensile stress, so contact with the side walls of the cooling system can be avoided. The cooling trough 42 may also comprise one or more returns for the traction element 38.

Upstream and downstream from the cooling trough 42 is arranged a control apparatus 44, 46, in each case for controlling the thickness d of the traction element 38, in particular. The measured dimensions are recorded and stored for the fully or partially automatic control of the production line 10 (for example adjustment of the wire unwinding 12, the preheating 26, 28, 30, the extruder 32 and the pressure rollers 40). Furthermore, the stored data can be used for statistical evaluations and quality reports.

The traction elements 38 are marked when passing through an automatically or manually operable inscription device 48, for example through an inkjet printer with an ink which adheres well on the surface of the traction element 38.

A caterpillar conveyor 50 with two continuously circulating bands ensures that a constant tractive force is exerted on the band-shaped traction element 38 and a constant running speed is maintained.

A subsequent roller store 52, also called an accumulator, has a plurality of rollers 58 held on a static stand 54 and on a mobile stand 56. The two stands 54, 56 are shown with a minimal spacing, in the normal working state. In the event of a change of roller, the roller store 52 has to receive the extruded traction element 38 for about 2 minutes, while the mobile stand 56 is displaced as indicated by dashed lines counter to the running direction 80. This mobile stand 56 is also used as a dancer and any irregularities in the band speed can be compensated by its displacement. When the roller store 52 is, for example, 70 to 75% filled, the band speed is reduced to the minimum value, which is about 10 m/min. By increasing the band speed downstream from the roller store 52 the normal working state shown by a continuous line 38 in FIG. 1 is produced as quickly as possible again.

Downstream from the roller store 52 a second caterpillar conveyor 60 is arranged according to the present embodiment with a preceding guide roller 62 on a holder 64. A cutting device 66 arranged downstream from the second caterpillar conveyor 60 cuts the traction element 38 to length when the storage roller 18 is full. The change of the storage roller 18 is matched to the roller store 52 and the change should be complete within 2 minutes. A guide roller 68 ensures regular winding of the traction element 38 onto the storage roller 18.

In the cross-section through a traction element 38 according to FIG. 2a, eight stranded cables 16 with a diameter Ø of 2.00 mm are embedded on a plane E at regular intervals a of 0.5 mm. These stranded cables 16 each have a core strand 124 and six peripheral strand cords 128 of in turn seven steel fibres 130, in each case (cf. FIG. 8). The stranded cables 16 have the same spacing a from the surfaces 70, 72. The traction element 38 has an overall thickness d of 3 mm and a width b of 25 mm.

A traction element 38 according to FIG. 2b has a longitudinal groove 17 on either side in the centre. A constriction 15 is formed thereby.

In the embodiment according to FIG. 2c, the traction element 38 has longitudinally extending constrictions 15 formed between the stranded cables 16 by longitudinal grooves 17 in the jacket 39. The longitudinal grooves 17 do not impair the tensile strength of the traction element 38, or only marginally. The traction element 38 is more flexible, however, as a whole, for example in the use as a tensioning element for fixing articles.

The outer contours of the jacket 39 are also fixed by the pressure rollers 40 (FIG. 1), which have a correspondingly structured jacket surface. The matrix opening of the extruder can be configured accordingly, but may also be elongate rectangular.

FIG. 2d shows a traction element 38 with stranded cables 16 of different thicknesses. The inner stranded cables 16 are smaller, the outer ones larger. On one side, the surface 72 of the jacket 39 is adapted to the diameter of the stranded cables 16, a broad longitudinal groove 17 is formed, and on the other side, the surface 70 is continuously smooth. This embodiment is suitable in turn for special purposes and the outer form of the jacket 39 is established in turn by the pressure rollers 40 (FIG. 1).

The embodiment according to FIG. 2e, in contrast to the previous examples, is asymmetrical in cross-section. The stranded cables 16 of different thicknesses are connected to one another by a connection web 15 and have a jacket 39 of approximately the same thickness everywhere.

FIG. 3 shows a horizontal section through a thread guide 74 and a matrix 76 at the level of the eight bores 78 corresponding to the thread diameter Ø for the stranded cables 16 running with little play in the running direction of the arrow 80, of which stranded cables only one is indicated as a part piece. Bores 84 run parallel to the screws 82 detachably connecting the thread guide 74 and the matrix 76, the bores having a diameter in the present case of 6 mm for feeding liquefied plastics material compound 86, which—invisibly on the sectional plane—is pressed into a matrix cavity 88 with the stranded cables 16 running through. The liquefied plastics material 86 sheaths the stranded cables 16. The composite leaves the discharge slot 116, which is elongate rectangular in cross-section, through the matrix opening 90 as a sheathed traction element 38.

FIG. 4 shows a vertical sectional plane placed through a stranded cable 16, through the thread guide 74 and matrix 76 according to FIG. 3. The stranded cables 16 are in turn guided in the running direction 80 through the thread guide 74 and the matrix 76. Prior to entry into the bore 78, the stranded cable 16 firstly passes through an outer inlet groove 92 and an inner smaller inlet groove 94, which simplify the production of the precise bores 78, lying closely together, for the stranded cables 16. A V-shaped inlet slot 96 is fed by way of the bores 84 according to FIG. 3 with liquefied plastics material compound 86.

By means of adjusting screws 98, 100, which act by way of guide plates 102, 104 on the matrix 76, the latter can be displaced in the vertical position by Δt of at most about 0.5 mm relative to the matrix 76. This displacement can take place at a precision of about 0.05 mm or less. In the case of a displacement of the matrix 76 by Δt, the stranded cable 16 is displaced inside the discharge slot 116 or the matrix opening 90 by the same amount. The stranded cable 16 can thus be positioned precisely inside the matrix opening 90. The position of the stranded cables in the traction element 38 is correspondingly precise (FIG. 2). The thread guide 74 can also be positioned by adjusting screws 108 and guide plates 110 in the same holder 106 as the matrix 76, if, instead of a continuous bore 112, adjusting screws are also arranged at the bottom in the thread guide 74. If the thread guide 74 is also displaceable, the mutual displacement range Δt can be correspondingly enlarged between the thread guide 74 and matrix 76.

In FIG. 5, the thread guide 74 and matrix 76 located on one another along a plane P are shown enlarged. The continuous, tensioned stranded cable 16 runs in the direction 80 through the thread guide 74 and the matrix 76. On displacement of the thread guide 74 along the plane P, the stranded cable 16 is entrained, because it is guided with very little play through the bore 78 (FIG. 4). If the matrix 76 is displaced with the thread guide 74 fixed, the stranded cable 16 remains untouched thereby. However, as the vertical position of the discharge slot 116 with the matrix opening 90 changes, the distance of the stranded cable 16 from the upper and lower limitation of the discharge slot 116 is changed. Thus the position of the stranded cable 16 in the centre of the discharge slot 116 can be established precisely by a simple displacement of the matrix 76 along the plane P in the vertical direction by one or a few tenths of millimetres. Therefore, the stranded cable 16 is adjusted precisely in the centre of the traction element 38, i.e. the jacket 39 is the same size on the upper and lower apex of the stranded cable.

In the embodiment according to FIG. 6, for co-extrusion, a further matrix 75 is arranged between the thread guide 74 and the matrix 76 and the same plastics material jacket 39 (FIG. 5) is applied consecutively in a spatially separated manner.

The matrix 76 for the traction element 38 (FIG. 5) has a projecting collar 114 with a lengthened discharge slot 116 and a discharge opening 90. Owing to the arrangement of the collar 114, the plastics material jacket 39 can cool better and harden better before discharge from the matrix opening 90.

The thread guide 74 comprises two peripheral bores 118 and two V-shaped inlet slots 96, also for the liquefied plastics material 86. The holes 78 for passage of the stranded cables 16 remain substantially unchanged, as do the outer and inner inlet groove 92, 94.

The further matrix 75 arranged between the thread guide 74 and the matrix 76 comprises two V-shaped inlet slots 96, which guide the fed liquefied plastics material 86 from the peripheral bores 118 to the matrix cavity 88. An advanced matrix cavity 120 is fed through the V-shaped inlet slot 96 in the thread guide 74. From this matrix cavity 120, a connection channel 122 leads to the matrix cavity 88 in the matrix 76, this connection channel 122 having a slightly larger diameter than the advanced bore 78. The stranded cable 16 passing through reaches the matrix cavity 88 already precoated.

According to a variant shown in FIG. 7, the thread guide 74 according to FIG. 6 is designed such that an impregnation means 87 for the stranded cable 16 is guided through the inlet slots 96 into the advanced matrix cavity 120. The liquefied plastics material compound 86 is guided through the inlet slots 97 into the matrix cavity 88. Obviously, various liquefied plastics material compounds 86 can also be guided through the inlet slots 96, 97.

FIG. 8 shows a cross-section through a stranded cable 16. A central strand cord, the core strand 124 is sheathed with a flexible thermoplastic plastics material layer 126, in the present case polyurethane. When stranding with six strand cords, the peripheral strand cords 128, the plastics material layer which is capable of flowing or viscous deforms and flows into the cable grooves. The individual fibres 130 of the core strand 124 and peripheral strand cords 128 are stranded in a manner which is known per se.

A stranded cable 16 with an outer diameter of at least about 5 mm, for example, can, as a single cable, achieve the tensile force required for a traction element. The stranded cable is preferably protected with an outer jacket made of plastics material.

Stranded cables 16 with a smaller diameter are guided in parallel through a production line 10 according to FIG. 1, sheathed with a plastics material 39 and used as a traction element 38 with a plurality of stranded cables 16.

The coating of a stranded part 16 or a core strand 124 can take place in any manner which is known per se or preferably with a modified production line according to FIG. 1, using the method according to the invention.

1-2. (canceled)

3. Traction element (38) according to claim 22, further comprising a plurality of stranded cables (16) extending in parallel and are embedded at a spacing (a) in a flexible thermoplastic plastics material jacket (39).

4. Traction element (38) according to claim 3, wherein a free surface of the stranded cables (16) is degreased or pretreated.

5. Traction element (38) according to claim 22, wherein the strand cables are made of threads selected from the group consisting of steel, aramid, glass, ceramic, carbon and mixtures thereof.

6. Production line (10) for embedding a plurality of stranded cables (16) in a flexible thermoplastic plastics material (39), which production line (10) comprises, in each case, a reel (14) for unwinding the stranded cables (16), a device (24) for the precise orientation of the stranded cables (16), a heater (26, 28, 30) for preheating the stranded cables (16), at least one extruder (32) for co-extrusion of the stranded cables (16) in a flexible plastics material jacket, a cooling trough (42), a roller store (52), a cutting device (66) and a storage roller (18), the extruder (32) has a thread guide (74) for the stranded cables and at least one matrix (76) which can be adjusted with and in relation to one another, individually, in a plane (P) angled with respect to the cable plane (E).

7. Production line (10) according to claim 6, characterised in that the stranded cables (16) are guided through a thread guide (74) and at least one matrix (75, 76), which can be adjusted in a range of (Δt) from ±0.5 to 2 mm at a precision of ± at least 0.1 mm relative to one another, the planes (E, P) extending at an angle of 45 to 135°.

8. Production line (10) according to claim 6, wherein the stranded cables (16) run through a thread guide (74) and at least one matrix (75, 76), which can be positioned with adjusting screws (98, 100, 108).

9. Production line (10) according to claim 6, wherein the stranded cables (16) pass through a thread guide (74) and at least one matrix (75, 76), which can be exchanged individually.

10. Production line (10) according to claim 6, wherein the cable guide (74) and a matrix (75, 76), formed in two or more parts, of the extruder (32) have two or more separate feed systems (96, 120 and 120, 88) for the liquefied plastics material (86).

11. Production line (10) according to claim 6, wherein at least two removable parallel pressure rollers (40) for stranded cables (16) passing through in the plane (E) are arranged directly downstream from the extruder (32) and can be adjusted at right angles to the stranded cables (16), individually with respect to the spacing.

12. Production line (10) according to claim 11, wherein two or four pressure rollers (40) are configured, which form a gap which is adjustable with respect to the position and the spacing or which are arranged offset with respect to one another in the running direction (80) of the traction element (38).

13. Production line (10) according to claim 6, wherein the matrix (76) of the extruder (32) has a cooling system.

14. Method for embedding at least one stranded cable (16) according to claim 22, wherein the stranded cable (16) is unwound from a reel, oriented, sheathed with liquefied plastics material (86), guided through at least two pressure rollers (40), cooled, and after passing through a roller store (52) and a cutting unit (66) for cutting to length, wound onto a storage roller (18), wherein the unwound stranded cable (16) is degreased and/or pretreated to improve the adhesion of the plastics material jacket (39), preheated to a temperature of about ±20° C. of the melting temperature of the flexible thermoplastic plastics material jacket sheathing the core strands (124) and sheathed in an extruder (32) with the liquefied plastics material (86).

15. Method according to claim 14, wherein the matrix (76) is heated by less than 40 to 100° C. compared to the thread guide (74).

16. Method according to claim 14, wherein the stranded cable (16) is guided at a running speed of 10 to 60 m/min through the extruder (32).

17. Method according to claim 14, wherein an adjustable tensile force of 5 to 100 N is maintained on the stranded cable (16).

18. Method according to claim 14, wherein the position a plurality of stranded cables (16) running in parallel on a plane (E) in an extruded traction element (38) is adjusted with respect to a plane (E) by individually height-adjustable pressure rollers (40), directly adjoining the extruder (32).

19. Method according to claim 18, wherein the extruded traction element (38) is guided through a cooling trough (42), having a temperature gradient in the running direction (80).

20. Method according to claim 14, wherein a pretreatment preceding the preheating takes place by means of a plasma treatment or application of an adhesive agent.

21. Method according to claim 14, wherein the stranded cable (16) is preheated with one of an induction heater (26), a flame burner (28), a warm air heater (30), an infrared heater to remove residual gases.

22. A flexible traction element capable of being wound and unwound, comprising at least one stranded cable comprising a core strand, a plurality of peripheral strand cords arranged around the core strand and a flexible thermoplastic material surrounding the core strand and extending at least partially into grooves formed by adjacent peripheral cords.
